(19) United States
(12) Patent Application Publication
(10) Pub. No.: US 2003/0113255 A1
(43) Pub. Date: Jun. 19, 2003

(54) Activated alumina and method of producing same

(76) Inventor: Wayne Harlan, Albuquerque, NM (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/305,707

(22) Filed: Nov. 27, 2002

Related U.S. Application Data
(60) Provisional application No. 60/333,193, filed on Nov. 27, 2001.

(51) Int. Cl. C01F 7/02

(52) U.S. Cl. 423/628

(57) ABSTRACT

An activated alumina formed by complexing a dehydrated alumina with an agglomerate blocking agent and then hydrating the activated alumina.

### CROSS-REFERENCE TO RELATED APPLICATIONS

This application is based on U.S. Provisional Application Serial No. 60/333,193 Entitled “Forming Alpha Activated Alumina with a Blocking Agglomerate,” filed on Nov. 27, 2001, which is hereby incorporated herein by reference.

### STATEMENT REGARDING FEDERALLY SPONSORED RESEARCH OR DEVELOPMENT

Not Applicable.

### FIELD OF THE INVENTION

The invention relates generally to inorganic chemistry and specifically to an activated alumina and a method for producing the activated alumina using a blocking agglomerate.

### DESCRIPTION OF RELATED ART

Aluminum oxide (alumina) occurs abundantly in nature, most often as impure hydroxides, e.g., as in bauxites and laterites. About 90% of alumina is used in the production of aluminum metal. The rest is consumed in other applications, including activated aluminas.

Activated aluminas are widely used in adsorption and catalysis where their relatively large surface areas, pore structure and surface chemistry play important roles. The catalytic reactivity of activated alumina is represented by its theoretical number of available active sites. The surfaces contain hydroxyl groups, oxides and aluminum ions. The three basic catalytic sites also have many possible logistical combinations.

The present invention is directed to a novel alpha-activated alumina having a formula of about ½ H₂O Al₂O₃ and a method of making the same.

### BRIEF SUMMARY OF THE INVENTION

The present invention forms an activated alumina by complexing a dehydrated alumina with an agglomerate blocking agent and forming a hydrated activated alumina.

### DETAILED DESCRIPTION OF PREFERRED EMBODIMENT

A. Activation of Alumina by Dehydration

To prepare the activated alumina using the method of the present invention, aluminum trihydroxide Al(OH)₃, such as that obtained for bayerite, gibbsite, and the like, is first rapidly heated to create a porous, poorly crystallized (amorphous), reactive, dehydrated transition alumina material. This flash calcination step creates an “activated” charged dehydrated transition alumina well known to those skilled in the art. Examples of methods for performing this flash calcination step and preparing the transition alumina are described more fully in U.S. Pat. Nos. 2,915,365; 3,222,129; 4,051,072; and 6,056,937, which are hereby incorporated herein by reference. Preferred activation conditions for the calcination step are temperatures of about 300 to 1400° C., preferably about 350 to 600° C., and an alumina powder residence time about 1 to 8 seconds, preferably less than about 7 seconds, and even more preferably less than about 3 seconds depending on the temperature. The transition alumina powder produced from the calcination step preferably has a residual water content of about 3 to 12%, as measured by weight loss on heating from 250 to 1100° C. Those skilled in the art will recognize that other methods of calcination may be employed to dehydrate or partially dehydrate the aluminum trihydrate to provide the activated dehydrated transition alumina.

The particle size of the transition alumina utilized will depend upon the desired activated alumina end product, and for purposes of the present invention preferably has a median particle size in the range of 0.1 to 300 microns, preferably 1 to 100 microns and typically 1 to 20 microns. In certain instances, it may be desirable to use a median particle size of 1 to 10 microns. In general, a narrow range of particle size produces a product with greater porosity, lower bulk density, and better diffusivity.

Suitable transition alumina powders are commercially available. Examples include Alcoa Activated Alumina Powders CP-7 and CP-1 of Aluminum Company of America.

B. Agglomerate Formation

The transition alumina is collected in a bag filter or placed directly into a blocking agglomerate/water solution to form a slurry containing an alumina/blocking agglomerate complex. Formation of the complex involves charge interactions between the alumina and the blocking agglomerate. As the complex is formed, the viscosity of the slurry is increased.

The blocking agglomerate is preferably comprised of one or more chelating agents. The chelating agent is even more preferably an organic diacid with an amine. Nonlimiting examples of chelators include oxalic acid, citric acid, saccharic acid, ethylene diamine tetraacetic acid (“EDTA”), nitrilotriacetic acid (“NTA”), hydroxyethylene-diaminetriacetic acid (“HEEDTA”), ethylenediaminedi-o-hydroxyphenylacetic acid (“EDDHA”), ethylene-glycolbis (2-aminoethylether) tetraacetic acid (“EGTA”), diethylenetriaminepentaacetic acid (“DTPA”), 1,2-diaminocyclohexanetetraacetic acid (“DCTA”), N,N-bishydroxyethylglycine, 4-(2-hydroxyethyl)-1-piperazineethanesulfonic acid (“HEPES”) and N-hydroxyethyliminodiacetic acid (“HIMDA”) and salts and derivatives thereof. A most preferred blocking agglomerate comprises derivatives of EDTA having the following formula:

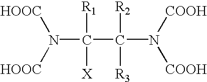

where X can be hydrogen, a hydroxyl, halogen, an alkyl C₁ to C₅, alkoxy C₁ to C₁₀, alkyl sulphonyl group C₄ to C₁₀; and where R₁, R₂, and R₃ can be hydrogen, a hydroxyl, an alkyl C₁ to C₅, an alkoxy C₁ to C₁₀, and an alkyl sulphonyl C₄ to C₁₀. Because of water solubility, the substituents X, R₁, R₂ and R₃ are preferably selected from hydrogen, the lower alkyl groups up to butyl, and the lower alkoxys up to butoxy. A most preferred agglomerating agent is a salt form of EDTA, and is most preferably calcium or sodium EDTA.

The blocking agglomerate/water solution is preferably buffered at pH between about 3 to 9, and more preferably below 7, and even more preferably below 4. The concentration of blocking agglomerate in the water is between about 0.5-15% wt/wt, and more preferably about 3-8% wt/wt.

The amount of blocking agglomerate/water solution used will vary depending upon the range and average particle size of the transition alumina. For example, where the transition alumina has a wide particle size range such as about 90% by weight of the alumina being in the 1 to 50 micron size range with an average particle size of about 35 microns, the blocking agglomerate/water solution required is about 33% of the weight of the alumina. Where the amorphous alumina has a narrow size range such as where 90% by weight of the alumina is in the range of about 1 to 20 microns with an average particle size of about 10 microns, the blocking agglomerate/water solution required is about 40% of the alumina weight. The higher water solution requirement results from the greater moisture holding capacity of the pellet having the narrow range particle size and smaller average size material.

The alumina/blocking agglomerate complex is then rehydrated to form a ceramic material. This rehydration step is well known to those skilled in the art. For example, the slurry containing the complex can be mixed with water and heated to make paste which is extruded to form pellets. Alternatively, a heated rotating pan may be used where the slurry is added to the pan and a water solution is sprayed on the slurry as the pan rotates. The rotating pan forms the slurry complex into spheres. In another method, spheres can be made from the viscous slurry of the transition alumina and blocking agglomerate/water solution using the so-called “oil drop” method. In the oil drop method, the slurry containing the alumina/blocking agglomerate complex is placed in a water immiscible liquid such as oil and heated to about 80 to 150° C., more preferably about 100° C., for about 2 to 8 hours, more preferably about 5 to 6 hours, whereby the alumina/blocking agglomerate complex form spheres. The resulting spheres are about ¼ of an inch in diameter.

The hydrated alumina within the complex naturally forms micropores. However, it is known to those skilled in the art that additional pore forming agents (such as wood, flour, cellulose) can be used to increase porosity.

D. Aging

The alumina/blocking agglomerate complex from the agglomerate forming step is preferably then aged in contact with liquid water or water vapor (steam) to further the rehydration reaction and develop maximum strength. This aging process creates a low density ceramic material. Where the oil drop method is used in the agglomerate forming step, the alumina/blocking agglomerate complex is preferably filtered from the oil and then water-treated for about 0.5 to 6 hours at about 150 to 250° C., preferably about 100° C. A wide variety of aging conditions can be applied to alter chemical purity and pore size distribution for specific applications, such as those described in U.S. Pat. Nos. 2,881,051; 3,222,129; 3,392,125; 3,480,389; 3,628,914; 3,928,236; 4,001,144; and 4,119,474. A preferred aging step involves heating the spheres with direct steam from a boiler for about one hour.

E. Removal of Blocking Agglomerate

The aged alumina/blocking agglomerate complex is then treated to remove the blocking agglomerate. In the preferred embodiment utilizing EDTA as the blocking agglomerate, the complex is heated (calcined) to convert the EDTA into carbon dioxide and nitrogen. The calcination preferably occurs between about 500 and 1200° C., preferably at about 721° C., for about 0.5 to 5 hours, preferably about 2 to 3 hours. Active sites are formed where the EDTA is removed. The resulting product is an activated alumina having a molecular formula of about ½ H₂O.Al₂O₃. The activated alumina preferably has an alpha-activated pore size of less than about 300 angstroms.

### EXAMPLES

### Example 1

About 533 gms of aluminum trihydroxide was air blown through a flame heated tube at 538° C. for an exposure time of 6.2 seconds. The resulting transition alumina powder was collected in a 1 liter Pyrex beaker containing 300 milliliters of deionized water held at a pH 4 with sodium phosphate buffer. The solution also contained 4.0 grams of calcium chelate disodium salt of EDTA. The resulting mixture formed a slurry with a viscosity of 250 centipoise.

The slurry mixture was then poured into an aluminum pan with equally spaced ⅜ inch holes throughout the bottom. The slurry was dripped through the holes at approximately 20 milliliter per minute into an hydrocarbon/silicon oil solution heated to 180° F. for about 1.5 hours. The droplets formed hardened spheres that were substantially uniform in shape. The temperature was raised to 212° F. for 30 minutes and the screen filtered with a metal mesh screen.

The ceramic spheres were then heated with direct steam from a boiler system for about 1 hour. This aging process created a low density ceramic material

The ceramic spheres were next placed into a furnace and heated at 721° C. for about 3 hours to drive off the EDTA. The final weight of the activated alumina was 478.6 gms.

As discussed below, the absorption of dissolved metals from a water solution was the about seven to ten times the rate of absorption of any existing activated absorption media.

### Example 2

This example shows the absorbance of the activated alumina prepared in accordance with Example 1 as compared to a conventional activated alumina. For this example, 500 gms of Alcan Aluminum AA-400 ⅛-inch granulated activated alumina was placed in 1 inch×2 foot Pyrex tube, with glass cotton inserted into one end to about 1 inch. The glass tube was inverted, so the glass cotton was on the bottom end of the Pyrex column.

A solution containing chromium, cobalt and nickel was then made. About 2.0 liters of deionized water was converted to a pH of 3 by adding hydrochloric acid. Then, 0.9 gms of cobalt nitrate, 0.87 gms of nickel chloride, and 0.92 gms of chromium oxide were added to the water solution. The metals were dissolved, by heating to 180° F. for two hours.

After cooling, the metal solution was placed in a 1 liter dropping flask over the vertical alumina column. The solution was dripped over the alumina column at 5 ml/minute. After the solution was passed over the bed, it was collected and analyzed.

For comparison, the Alcan Alumina was removed and replaced with the inventive activated alumina material of Example 1. The same weight (500 gms) was placed into the glass column with glass cotton. The second half of the metal solution was the control dripped at 5 ml/minutes. The filtrate was collected and analyzed.

The amount of metal in the filtrate is shown in Table 1:

TABLE 1

| | Comparative | |
|---|---|---|
| | (Alcan) | Inventive |
| Metal | (gms) | (gms) |
| Cobalt | 0.23 | 0.023 |
| Nickel | 0.31 | 0.032 |
| Chromium | 0.32 | 0.024 |

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A method of preparing partially hydrated activated alumina comprising:
providing a substantially dehydrated activated alumina;
rehydrating the substantially dehydrated activated alumina in the presence of a blocking agglomerate which forms an alumina/blocking agglomerate complex; and
removing the blocking agglomerate from said complex to provide a partially hydrated activated alumina.

2. The method of claim 1 wherein the substantially dehydrated activated alumina is prepared by calcination of aluminum trihydroxide.

3. The method of claim 2 wherein said calcination comprises subjecting aluminum trihydroxide to a temperature of about 300 to 1400° C. for about 1 to 8 seconds.

4. The method of claim 1 wherein the substantially dehydrated activated alumina has a particle size of about 0.1 to 300 microns.

5. The method of claim 1 wherein said rehydrating step comprises subjecting said substantially dehydrated active alumina to a water solution containing a blocking agglomerate and then heating in the presence of a water immiscible liquid.

6. The method of claim 5 wherein said solution is maintained at a pH between about 3 and 9.

7. The method of claim 5 wherein said solution comprises about 1% to 15% wt/wt of the blocking agglomerate.

8. The method of claim 1 wherein said blocking agglomerate is a salt an acid having the following formula: 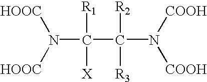
where X can be hydrogen, a hydroxyl, halogen, an alkyl C₁ to C₅, alkoxy C₁ to C₁₀, alkyl sulphonyl group C₄ to C₁₀; and where R₁, R₂, and R₃ can be hydrogen, a hydroxyl, an alkyl C1 to C₅, an alkoxy C₁ to C₁₀, and an alkyl sulphonyl C₄ to C₁₀.

9. The method of claim 1 wherein said blocking agglomerate is selected from the group consisting of oxalic acid, citric acid, saccharic acid, ethylene diamine tetraacetic acid, nitrilotriacetic acid, hydroxyethylene-diaminetriacetic acid, ethylenediaminedi-o-hydroxyphenylacetic acid, ethylene-glycolbis (2-aminoethylether) tetraacetic acid, diethylenetriaminepentaacetic acid, 1,2-diaminocyclohexanetetraacetic acid, N,N-bishydroxyethylglycine, 4-(2-hydroxyethyl)-1-piperazineethanesulfonic acid, and N-hydroxyethyliminodiacetic acid and their salts.

10. The method of claim 9 where in said blocking agglomerate is a salt of ethylene diamine tetraacetic acid.

11. The method of claim 10 wherein said salt comprises a calcium or sodium salt.

12. The method of claim 1 wherein said alumina/blocking agglomerate complex is aged by contacting the complex with liquid water or water vapor prior to removal of the blocking agglomerate.

13. The method of claim 1 wherein said blocking agglomerate is removed from the alumina/blocking agglomerate complex by application of thermal energy.

14. The method of claim 13 wherein said alumina/blocking agglomerate heated at about 500 to 800° C. for about 2 to 8 hours.

15. The method of claim 14 wherein said blocking agglomerate comprises ethylene diamine tetraacetic acid, and said heat cause said ethylene diamine tetraacetic acid to form carbon dioxide and nitrogen.

16. A partially hydrated activated alumina prepared by:
providing a substantially dehydrated activated alumina;
rehydrating the substantially dehydrated activated alumina in the presence of a blocking agglomerate which forms an alumina/blocking agglomerate complex; and
removing the blocking agglomerate from said complex to provide a partially hydrated activated alumina.

17. The partially hydrated activated alumina of claim 16 wherein the substantially dehydrated activated alumina is prepared by calcination of aluminum trihydroxide.

18. The partially hydrated activated alumina of claim 17 wherein said calcination comprises subjecting aluminum trihydroxide to a temperature of about 300 to 1400° C. for about 1 to 8 seconds.

19. The partially hydrated activated alumina of claim 16 wherein the substantially dehydrated activated alumina has a particle size of about 0.1 to 300 microns.

20. The partially hydrated activated alumina of claim 16 wherein said rehydrating step comprises subjecting said dehydrated active alumina to a water solution containing a blocking agglomerate and then heating in the presence of a water immiscible liquid.

21. The partially hydrated activated alumina of claim 20 wherein said solution is maintained at a pH between about 3 and 9.

22. The partially hydrated activated alumina of claim 20 wherein said solution comprises about 1% to 15% wt/wt of the blocking agglomerate.

23. The partially hydrated activated alumina of claim 16 wherein said blocking agglomerate is a salt an acid having the following formula: 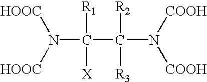
where X can be hydrogen, a hydroxyl, halogen, an alkyl C₁ to C₅, alkoxy C₁ to C₁₀, alkyl sulphonyl group C₄ to C₁₀; and where R₁, R₂, and R₃ can be hydrogen, a hydroxyl, an alkyl C1 to C₅, an alkoxy C₁ to C₁₀, and an alkyl sulphonyl C₄ to C₁₀.

24. The partially hydrated activated alumina of claim 16 wherein said blocking agglomerate is selected from the group consisting of oxalic acid, citric acid, saccharic acid, ethylene diamine tetraacetic acid, nitrilotriacetic acid, hydroxyethylene-diaminetriacetic acid, ethylenediaminedi-o-hydroxyphenylacetic acid, ethylene-glycolbis (2-aminoethylether) tetraacetic acid, diethylenetriaminepentaacetic acid, 1,2-diaminocyclohexanetetraacetic acid, N,N-bishydroxyethylglycine, 4-(2-hydroxyethyl)-1-piperazineethanesulfonic acid, and N-hydroxyethyliminodiacetic acid and their salts.

25. The partially hydrated activated alumina of claim 24 where in said blocking agglomerate is a salt of EDTA.

26. The partially hydrated activated alumina of claim 25 wherein said salt comprises a calcium or sodium salt.

27. The partially hydrated activated alumina of claim 16 wherein said alumina/blocking agglomerate complex is aged by contacting the complex with liquid water or water vapor prior to removal of the blocking agglomerate.

28. The partially hydrated activated alumina of claim 16 wherein said blocking agglomerate is removed from the alumina/blocking agglomerate complex by application of thermal energy.

29. The partially hydrated activated alumina of claim 28 wherein said alumina/blocking agglomerate heated at about 500 to 800° C. for about 2 to 8 hours.

30. The partially hydrated activated alumina of claim 16 wherein said alumina has the formula about ½ H₂O Al₂O₃

31. The partially hydrated activated alumina of claim 30 wherein said activated alumina comprises an alpha-activated alumina.
